(19) United States
(12) Patent Application Publication
(10) Pub. No.: US 2007/0125715 A1
(43) Pub. Date: Jun. 7, 2007

(54) Flotation separator

(76) Inventors: Bjorn Christiansen, Porsmyra (NO); Knut Sveberg, Nordslettveien (NO); Inge Hjelkrem, Elgesetergate (NO); Dag Kvamsdal, Nedre Bakklandet (NO)

Correspondence Address: DENNISON, SCHULTZ & MACDONALD, 1727 KING STREET, SUITE 105, ALEXANDRIA, VA, 22314, US

(21) Appl. No.: 10/581,126

(22) PCT Filed: Nov. 24, 2004
(86) PCT No.: PCT/NO04/00360

§ 371 Date: Jun. 13, 2006

(30) Foreign Application Priority Data
Dec. 11, 2003 (NO) 20035513
Mar. 15, 2004 (NO) 20041073

(51) Int. Cl. C02F 1/24

(52) U.S. Cl. 210/703

(57) ABSTRACT

A flotation separator for the separation of a dispersed liquid phase and/or suspended solid materials from a continuous liquid phase containing free gas including; an open or closed vessel (1) which is completely or partially liquid filled, is equipped with one or several inlet nozzles (2) feeding the inflowing mixture through one or several distribution chambers (13) toward one or several substantially vertically arranged cyclone pipes (15). Each cyclone pipe (15) is equipped with a swirl generating inlet device (14), a lower exit (16) where continuous liquid phase is exiting the cyclone pipe (15), and an upper exit (17) where gas, the dispersed liquid, and/or suspended solids, together with parts of the continuous liquid phase are exiting the cyclone pipe (15). The upper exit port (17) of the cyclone pipe or pipes (15) is completely or partially submerged in the continuous liquid phase.

The current invention concerns seperation of liquid droplets or solid materials from a liquid flow, and specifically related to oil and gas dominated process.

### BACKGROUND

When producing oil and gas from a sub-terrain or sub-seabed reservoir the well flow will almost always contain oil, gas, water and traces of solids/sand. On the downstream end of the well flow, production plants are found with the primary task of separating the different phases from each other. This separation occurs usually in several stages, where the primary separation is using gravitation alone while the final separation stages uses different technologies that principally are based on centrifugal accelerations or a combination with gravitation. The water separated from the well flow is commonly termed; produced water. A common challenge is to remove oil droplets from the produced water phase prior to discharging the resulting water to the sea. For this situation is the feed concentration of oil in water low, preferably less than 0.1% by volume. Gas flotation represents a common separation technique for such an application, preferably applied as final separation stage arranged downstream hydro cyclones. Gas flotation includes an introduction of gas into the water; eventually the existing gas in solution can be used for the purpose. The resulting mixture, i.e. the continuous water phase, the dispersed oil droplets and the dispersed gas bubbles is led into a closed vessel which is partially filled with water, i.e. a free liquid water surface exist. Due to the density differences between the gas and the water, gas bubbles will raise to the liquid surface due to buoyancy. In the wake trailing the raising bubbles water and oil droplets will be transported toward the liquid surface. At the liquid surface the oil droplets will coalesce and eventually a continuous oil layer will form. The oil droplets have also an affinity to the gas bubbles such that the oil droplets are attached to the same bubbles and hence the transport toward the liquid surface is more effective. The oil layer can be removed continuously or periodically by letting the oil layer flow over a weir plate and exit the vessel through a designated pipe outlet. The purified water is led out of the vessel through a pipe outlet at the bottom of the vessel, while the gas is exiting through a pipe outlet in the roof of the same vessel.

In connection with the purification of produced water from the well flow there will also be hydro carbon gases in solution which will be released when the pressure of the produced water is reduced. The vessel has also as a function to separate this gas in addition to remove oil droplets. Such vessels are commonly termed degassing vessel in the oil and gas business area. In the situation where there is not sufficient gas present in the produced water to achieve the flotation effect wanted, it is common practice to add additional quantities of hydro carbon- or nitrogen gases to the produced water flow. Gas flotation is also used to separate solid materials from a liquid flow. The most common application is within mining business where dust is removed from the water and within waste water treatments where fine particles are removed by said technique. Common for the applications is that the particles are too small or exhibit a little density difference compared with the continuous liquid such that gravity alone is not efficient as a separation mechanism. For such situations a flotation gas is added together with a foam generating substance making the solids end up bonded in a foam layer at the liquid surface. A mechanical apparatus periodically removes the foam layer. For such an application the flotation separation can be represented by a vessel or a pool exposed to the atmosphere and not within a closed vessel which is common for hydro carbon flows. The flotation gas will in an open system be air, nitrogen, oxygen or any gas not hazardous to the environment.

Lately flotation technology has been applied that combines centrifugal forces in combination with gravity for the combined removal of gas and oil droplets from produced water. The Norwegian patent application NO20031021 describes one such flotation separator where the inflow mixture is entering the vessel through a tangentially arranged inlet pipe such that a rotating flow field is established within the vessel. The rotation makes the flow experience a centrifugal force in addition to gravity. In order to balance the centrifugal force a pressure gradient establishes in the radial direction where the minimum pressure is found at the vessel center region. The gas bubbles will therefore migrate toward the center where the gas concentration is increased and migrate upward due to buoyancy. The flotation effect on dispersed oil droplets will be similar to that explained for conventional separation vessels. A limitation with the described method is that the whole vessel is used in order to achieve a cyclone effect. The centrifugal force is inverse proportional to the diameter of the vessel; i.e. there will be limitation on the size of single vessels and therefore the capacity for individual vessels. A lower centrifugal force can be compensated with extended residence times, but this will also pose a limit of the capacity of individual vessels.

The use of inlet cyclones in separation vessels is a known technology in connection with the separation of gases from liquids and is described in GB patent 2329857 and international application PCT/GB98/03453 (publication number W099/25454). The objective with inlet cyclones is to make an instant separation of gas and liquids when the mixture enters the vessel. Inlet cyclones have an inlet that communicates with the vessel inlet nozzle, a liquid flow outlet leading the separated liquid down into the liquid layer of the vessel, and a gas flow outlet leading separated gas into the gas section of the vessel. In the subsequent text the term flotation separator is used to describe all types of separators with the purpose of separating a dispersed liquid phase or solids from a continuous liquid phase, preferably water, where gas in solution and/or added gas are used for achieving the flotation effect.

Objective

The objective of the current invention is to provide an inlet cyclone arrangement suited for installment in existing and new flotation separators and that exploits centrifugal forces to enhance the separation effectiveness and capacity compared with flotation separators of known technology without introducing new operational concerns or limitations which are associated the application of inlet cyclones of known technology.

The invention

The current invention is concerned a flotation separator for the removal of dispersed liquid and/or solids from a liquid flow, and characterized by the claims defined in claim 1. The preferred embodiment of the invention derives from the dependent patent claims. The flotation separator according to the invention consists of an open or closed vessel equipped with one or more inlet nozzles and a distribution system leading the feed flow, consisting of one continuous liquid phase, free gas and a dispersed liquid and/or solids, toward at least one but preferably several vertically and parallel oriented cyclones that while operating will be submerged in the continuous liquid phase within the vessel. Each cyclone has one inlet and two outlets, where one outlet is at the lower end of the cyclone feeding the separated continuous liquid to the vessel and the other exit at the upper end feeding the originally dispersed liquid and/or solids together with the flotation gas. Contrary to inlet cyclones of known technology, which are applied for gas/liquid separation and characterized by the upper exit is communicating with the gas section of the vessel, the upper outlet of the current invention is arranged at a vertical level which under operation will be submerged by the continuous liquid phase.

When the term “beneath the liquid surface” is used, the proper meaning is beneath the free liquid surface of the continuous liquid phase that accumulates in the vessel lower compartment. Similarly the term submerged in the liquid phase, the proper meaning is submersion in the continuous liquid phase that accumulates in the vessel lower compartment.

The cyclone(s) has a swirl-generating inlet device that makes the inflow start to rotate such that the inflowing fluid is imposed a centrifugal force in addition to gravity. As a consequence of the centrifugal force a radial pressure gradient will form making the minimum pressure in the center region of the cyclone. The gas bubbles will therefore migrate toward the center where they accumulate and migrate due to gravity upward and exit through the cyclone's upper exit and further through the volume of liquid above the cyclone(s) until they reach the liquid surface within the vessel, or in the case of a completely liquid filled vessel; the gas bubble are led out of the vessel through a pipe outlet together with the dispersed phase and part of the continuous liquid phase. In the wake trailing the gas bubbles, a radial and upward directed flow field establish that contribute to the transport of the dispersed phase toward the center of the cyclone, out through the cyclone upper exit and toward the liquid surface within the vessel or in the case of a completely liquid filled vessel; the dispersed phases are led out of the vessel through a pipe outlet together with the gas bubbles and part of the continuous liquid phase. The dispersed phase also has an affinity to the gas bubbles such that the droplets/particles are attached to the gas bubbles and therefore transported by the same gas bubbles. The layer containing the dispersed phase can be removed continuously or periodically by letting the accumulated layer of the dispersed phase flow continuously out of the vessel through a separate pipe outlet together with parts of the continuous liquid phase. The gas is led out of the vessel through a pipe outlet in the roof of the vessel. The accumulated dispersed phase can alternatively be led out of the vessel together with the gas through a common pipe outlet. The purified produced water is led out of the flotation separator through a pipe outlet located at the lower end of the vessel.

The liquid volume of the flotation separator can be considered as split into two sections that are completely or partially separated at the upper exit of the cyclone, whereof the lower liquid section is collecting liquid from the lower exit of the cyclone while the upper liquid section is more quiescent and is used for flotation of the accumulated dispersed phase escaping the upper exit of the cyclone.

In the subsequent sections the invention is described in more detail, also applications according to previously known techniques is described for comparison, with reference to figures. Subsequent examples are illustrated with vertical- and horizontal arranged vessels, but any vessel shape e.g. spherical, rectangular or an open pool is suitable for the duty.

The subsequent discussion is based on a flotation separator applied for purification and de-gassing of produced water, but the same technique can be used for removing any dispersed liquid or solid from a continuous liquid phase where flotation gases are added or already present as free gas in the liquid.

### FIGURES

FIG. 1 shows schematically a cross sectional view of a flotation separator based on common known technology,

FIG. 2 shows schematically a cross sectional view of a flotation separator based on known technology where the inflowing liquid is given a rotation,

FIG. 3 shows schematically a cross sectional view of known liquid/gas separator equipment with a cyclone inlet where both the inlet and the gas outlet are found above the free surface of the liquid,

FIG. 4 shows schematically a cross sectional view of known gas/liquid separator technology where the cyclone inlet is submerged beneath the liquid surface, but the gas exit (17) is above the liquid surface,

FIG. 5 shows schematically a first example according to the current invention of a flotation separator with a cyclone inlet where the outlets (16) and (17) are both beneath the liquid surface,

FIG. 6 shows schematically a second example according to the current invention where all or parts of the gas is allowed to exit the cyclone pipe (15) through an annulus formed by the cyclone pipe and the concentric arranged exit pipe (19). The exit pipe (19) can, with such a design, be closed at the upper end, but the preferred embodiment is an open solution,

FIG. 7 show schematically a third example according to the current invention where parts of the gas is allowed to flow into the exit pipe (19) through slits or perforations located on the exit pipe's (19) sidewall,

FIG. 8 shows schematically a second example according to the current invention of a flotation separator with several inlet cyclones in parallel where the exits (16) and (17) are both submerged in the liquid phase,

FIG. 9 shows schematically a third example according to the current invention of a flotation separator with several inlet cyclones in parallel where the exits (16) and (17) are submerged in the liquid phase and where the separated dispersed phase is led through a common exit together with the gas and parts of the continuous liquid phase,

FIG. 10 shows schematically a forth example according to the current invention where a horizontally arranged flotation separator is fitted with several cyclone inlets in parallel and where the exits (16) and (17) are submerged in the liquid phase,

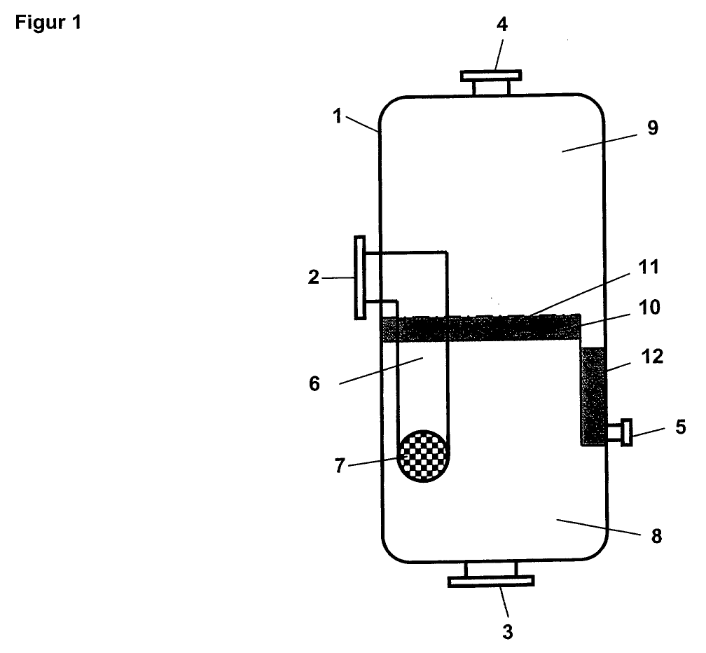

FIG. 1 shows a flotation separator according to known technology where the inflowing mixture is led into the vessel (1) through an inlet pipe (2) and further into the vessel's (1) water section (8) through a pipe (6) with a perforated exit section (7) spreading the mixture in the vessel's (1) horizontal cross section. The gas bubbles will thereafter rise through the vessels water section (8) until the liquid surface (11) is broken and the content of the gas bubbles is taken by the vessels (1) gas section (9). In the wake trailing the raising gas bubbles water and oil droplets will be transported through the vessel's water section (8) toward the liquid surface (11) where the oil droplets will coalesce and eventually accumulate and form an oily layer (10). The oil droplet also have a direct affinity to the gas bubbles such that oil droplets are attached to the gas bubbles and hence effectively transported toward the liquid surface (11). The oil layer (10) forming on the liquid surface (11) can be removed continuously or periodically by letting the oil layer (10) flow over a weir plate (12) and be led out of the vessel in a designated exit nozzle (5). The purified water is led out of the vessel through an exit nozzle (3) located in the lower part of the vessel (1) while the gas is exiting through an exit nozzle (4) in the upper part of the vessel (1).

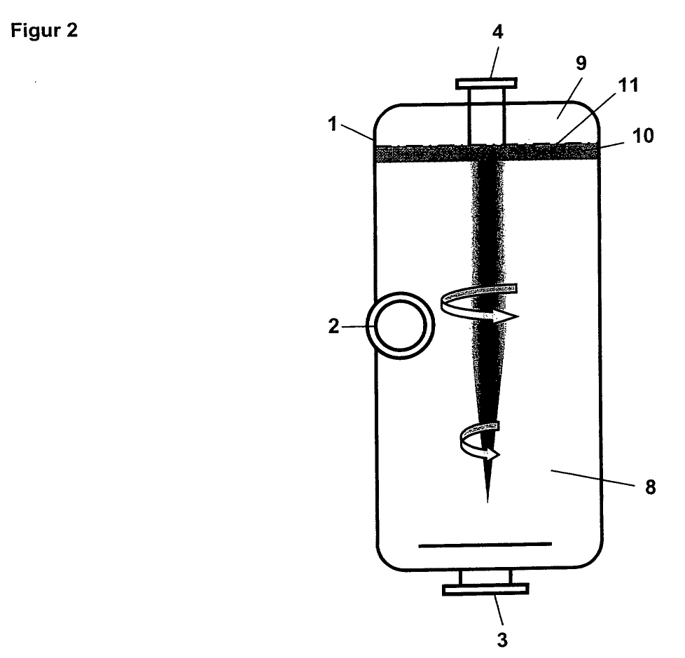

FIG. 2 shows a flotation separator according to known technology where inflowing liquid is led into the vessel (1) through a tangentially arranged inlet pipe (2) such that a rotating flow establishes within the vessel (1). Due to the rotation an inflowing liquid will experience a centrifugal force in addition to gravitation. In order to counter balance the centrifugal force a radial pressure gradient will develop where the lowest pressure is found in the center of the vessel (l). The gas bubbles will therefore migrate toward the center region of the vessel where the bubbles accumulate a due to gravity will raise vertically due to gravitation. The flotation effect on dispersed oil droplets will be similar to that explained for conventional flotation separators.

The accumulated oil is discharged together with the gas and parts of the continuous liquid phase through a common outlet nozzle (4). The purified water is discharged from the vessel through an exit nozzle (3) located in the lower end of the vessel (1). A limitation with the described flotation method is that the whole vessel (1) volume is used for achieving the cyclone effect. Since the centrifugal force achieved is inversely proportional to the diameter of the vessel, this will limit the size of the vessel and hence the capacity of produced water that can be treated per vessel. Lower centrifugal forces can be compensated with increased residence times, but this will also limit the amount of produced water to be treated per vessel.

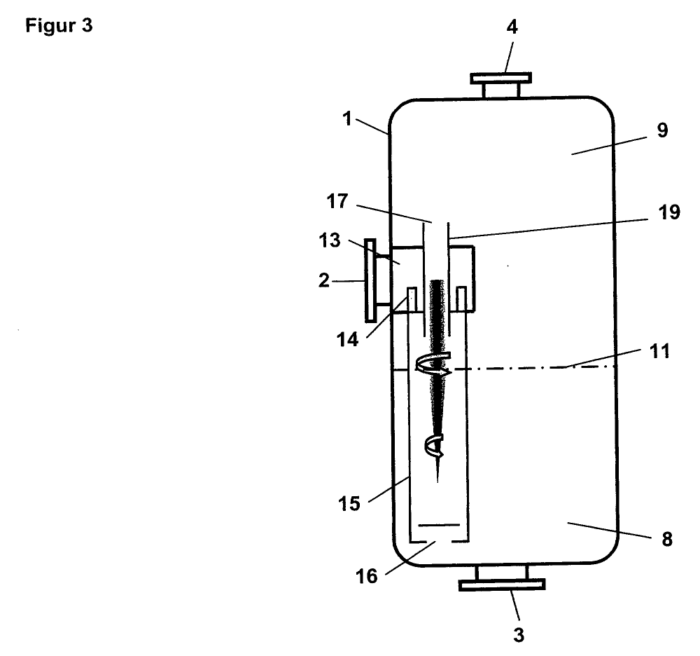

FIG. 3 shows according to know technology the use of an inlet cyclone in a separator vessel used for the separation of gas and liquid without the use of flotation. The purpose of the inlet cyclone is to instantly separate gas and liquid upon mixture entry into the vessel (1). The inlet cyclone consists of a swirl generating inlet (14) which is communicating with the vessel inlet nozzle (2) through a distribution chamber (13) or a conduit, a cyclone pipe (15), a liquid exit (9) leading the separated liquid down into the liquid section (8) and a gas exit (17) leading separated gases into the vessel's gas section (12). The swirl generating inlet (14), which can be of any type e.g. one or several tangentially located ports or vanes, forces inflowing liquid and eventually dispersed solid to rotate within the cyclone pipe (15) such that the inflowing liquid experience centrifugal forces in addition to gravitation. Due to the centrifugal forces a radial pressure gradient field establishes where the lowest pressure is found in the center region of the cyclone pipe (15). The gas bubbles will therefore migrate toward the center of the cyclone pipe (15) where the gas bubbles accumulates and due to the action of gravity raise vertically upwards and exit through the cyclone's upper exit (17) that is communicating with the vessel's (1) gas section (8). In FIG. 3 both the vessel's pipe inlet (2), the cyclone's distribution chamber (13) and the cyclone's gas exit (17) is located above the liquid surface (11). In FIG. 3 only one cyclone is shown, but several cyclones can operate in parallel.

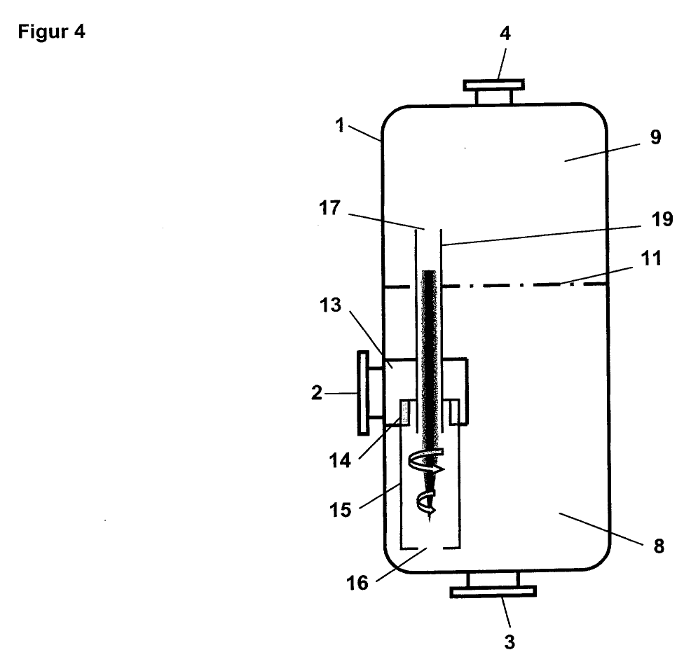

FIG. 4 shows according to known technology another embodiment of a inlet cyclone used in separators for the separation of gas and liquids. Such an embodiment has the same functionality as that shown in FIG. 3, but for the current solution both the vessel's pipe inlet (2), the cyclone's distribution chamber (13) are beneath the liquid surface (11). The cyclone's gas exit (17) is however above the liquid surface.

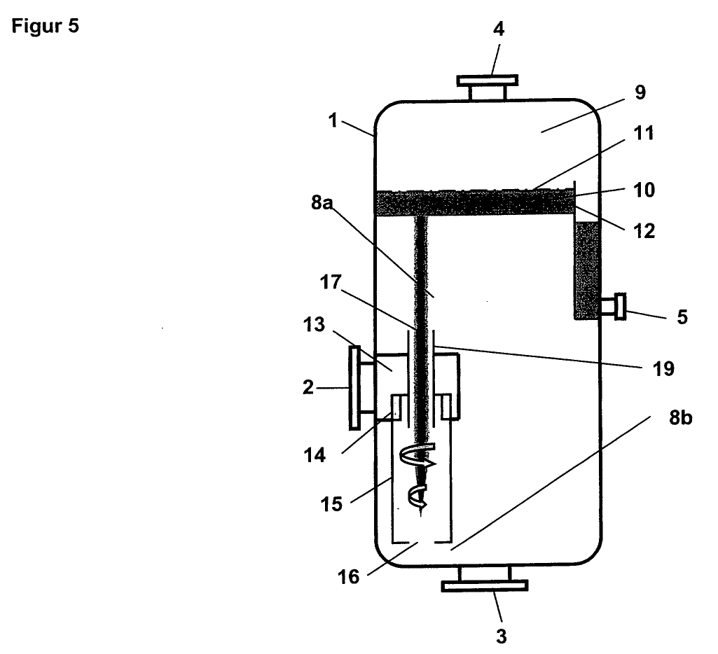

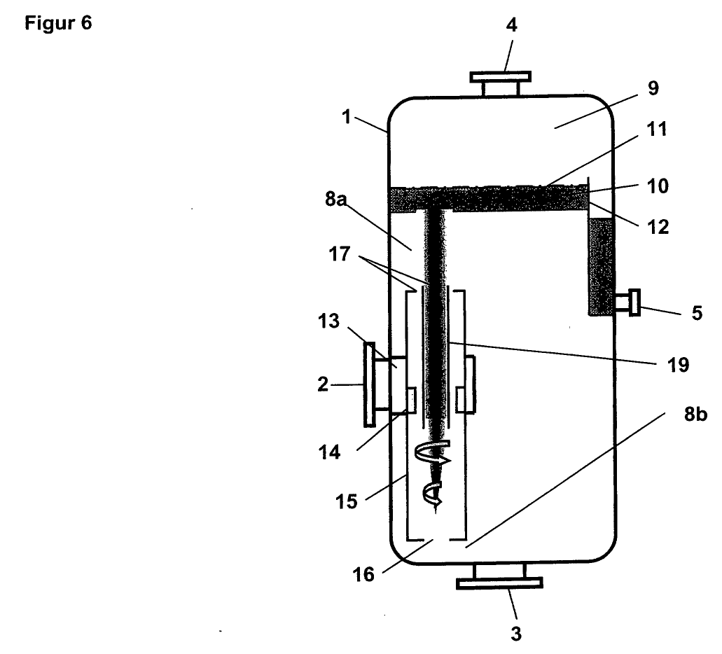

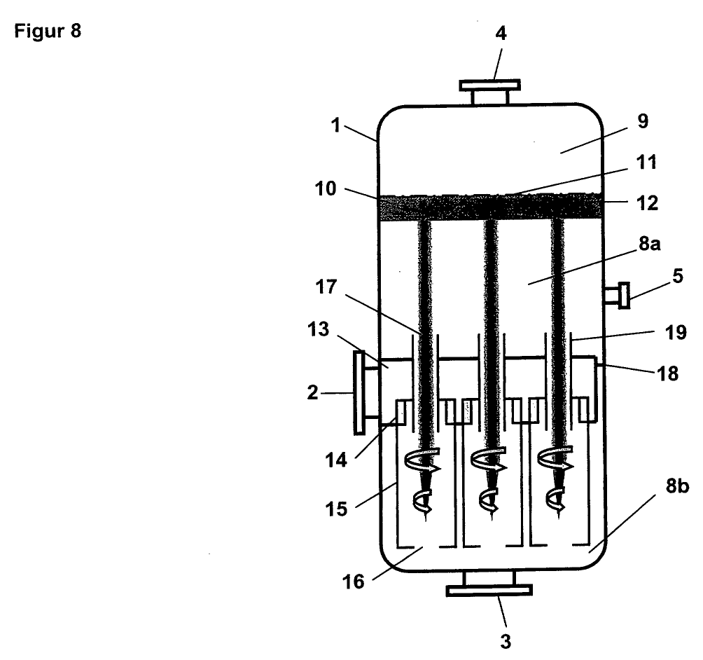

FIGS. 5, 6, 7, 8, 9 and 10 show different embodiments of a flotation separator according the current invention which contain one or several pipe inlets (2) and one or several distribution chambers (13) leading the inflowing liquid or liquids into on or several vertically arranged cyclone pipes (15) being submerged in the continuous liquid phase. A typical gas ratio is 20% by volume of the liquid flow. In lack of sufficient gas content in the produced water, flotation gas is being added either in the pipe length upstream the pipe inlet (2), preferably in a combination with chemicals that enhance droplet coalescing, or in the distribution chamber (12) such that a more even distribution of gas for each parallel arranged cyclone pipe (15) is ensured. For the former solution a mixing unit is often employed for ensuring good mixing of added flotation gas and chemicals in the produced water. Each cyclone pipe (15) has a swirl generating inlet (14) of any kind, for example en or several tangentially arranged inlet ports or vanes, forcing the inflowing liquid to rotate within the cyclone pipes (15). Each cyclone pipe (15) has two exits; one lower exit (16) leading purified produced water into the vessel's water section (8b) beneath the cyclones and one upper exit (17) leading separated gas and oil droplets and eventual solids up into the vessel's water section (8a) above the cyclones. The most significant characteristic with the current invention is that the upper exit (17) of the cyclone when operating is completely or partially submerged in the continuous water phase (8). By partially submerged it's meant that slits or perforations (20) are arranged on the upper parts of the exit pipe (19) as is illustrated in FIG. 8. The elevation of the cyclone pipes' top upper (17) is therefore defined to coincide with the lower edge (21) of the slits or perforations (20).

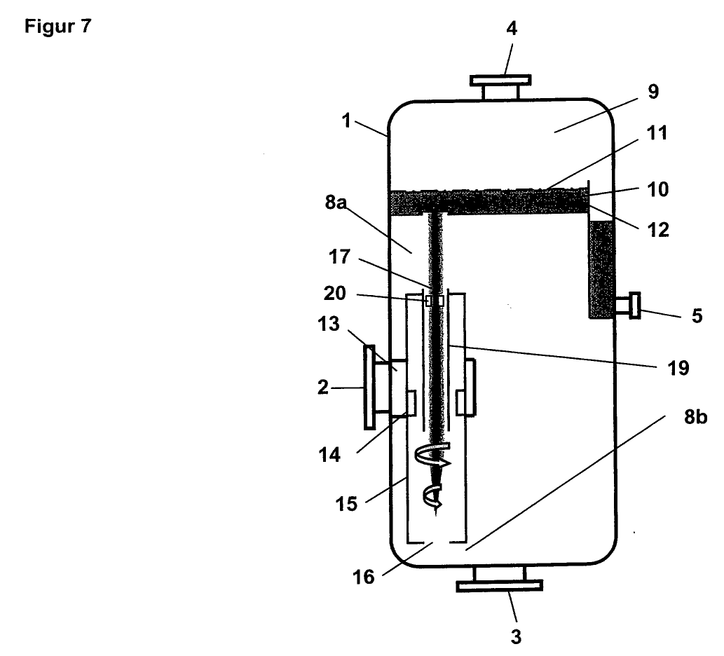

The upper exit (17) can be represented by a upper end of an exit pipe (19) as is illustrated in FIG. 5, 7, 8, 9 and 10. The upper exit (17) can also take alternative designs such as shown in FIG. 7 where the gas is allowed to also flow out of the cyclone pipe (15) through an annulus formed by the cyclone pipe (15) and the concentric arranged exit pipe (19). The exit pipe (19) having such a design can be closed at the top, but the preferred embodiment is open.

Parts of the gas can also be allowed to flow into the exit pipe (19) through slits or perforations arranged on the exit pipe (19) sidewalls, such as shown in FIG. 7, before the gas reaches the upper exit (17).

Due to the rotation within the cyclone pipes (15) the inflowing liquid is affected by a centrifugal force in addition to gravitation. A consequence of the centrifugal forces is that a pressure gradient field in the radial direction establishes creating a minimum pressure in the cyclone pipe's (15) center region. The gas bubbles will therefore migrate toward the cyclone pipe's (15) center region, where the bubbles accumulate, and, due to gravity, migrate vertically and exit through the cyclone's upper exit (17) and through the water section (8a) above the cyclone's upper exit (17) until the liquid surface is broken and the gas is released.

In the wake trailing the gas bubbles radial and upward directed flow fields establish that contribute to the transport of the dispersed phase toward the center of the cyclone (15), out through the cyclone upper exit (17) and toward the liquid surface (11) where the oil droplets coalesce and eventually form a continuous oily layer (10). The oil droplet also have a direct affinity to the gas bubbles such that oil droplets are attached to the gas bubbles and hence effectively transported toward the liquid surface (11). In a preferred embodiment of the current invention the dispersed liquid phase together with parts of the continuous phase is led out of the vessel in a designated exit nozzle (5). The purified water is led out of the vessel through an exit nozzle (3) located in the lower part of the vessel (1) while the gas is exiting through an exit nozzle (4) in the upper part of the vessel (l).

It's preferred to use a high number of cyclone pipes (15) within the vessel (1) such as illustrated in FIGS. 8, 9 and 10 due the following reasons;

A long residence time is obtained within the cyclone pipes (15) where the separation mainly takes place. The flux velocity of liquid within the cyclone pipes, defined as the total liquid volume flow divided by the total number of cyclones and the cyclones' cross sectional area, is typically in the range 0.5 m/s to 1 m/s for applications of cyclones with the primary task of separating liquid and gas. Flotation of oil droplets and/or solid material from water demands flux velocities below 0.3 m/s, but preferably less than 0.1 m/s.

In the sub sequent text the continuous liquid phase is also notified as water phase, while the dispersed phase is also notified as oil- or oil phase.

The water volume within the flotation separator can be considered split in two sections that are completely or partially separated at the upper end of the cyclone's distribution chamber (13), whereof the lower water section (8b) collects water from the lower exit (16) of the cyclone while the upper water section (8a) is more quiescent and is used for flotation of the accumulated dispersed phase exiting the upper exit (17) of the cyclone. The cyclone's distribution chamber (13) can therefore be used to isolate the upper water section (8a) such that this section has little- or any influence from the turbulence existing in the lower water section (18). It's therefore preferred that the continuous water phase is as quiescent as possible in the upper water section (8a). This can best be achieved by arranging a plate (18) that completely or partially is enclosing the area between the cyclone(s) and the side walls of the vessel at a level corresponding to the upper or lower edge of the distribution chamber (13) as is shown in FIGS. 8, 9 and 10. Alternatively two enclosing plates (18) can be applied where one plate is used for above the pipe inlet (2) and the other plate below the pipe inlet (2) such that the volume in between represents the distribution chamber (13) that communicate with the cyclones' (15) inlets (14). By isolating the upper water section (8a) from the lower water section (8b) using one or two enclosing plates (18) the only exchange between the two sections will be through the cyclone's upper exit (17). In a preferred application of the current invention using the latter arrangement it's possible to control the quantity of continuous water phase that flows together with the gas and the dispersed oil phase through the cyclone pipe's (15) upper exit (17) improving separation effectiveness with respect to dispersed oil removal. As an alternative solution to isolate the two water volumes in two sections (8a) and (8b) using one or two enclosing plates (18) the lower liquid exit (16) of the cyclone pipe (15) can be joined using a manifold which is communicating directly with the vessel's (1) lower exit nozzle (3).

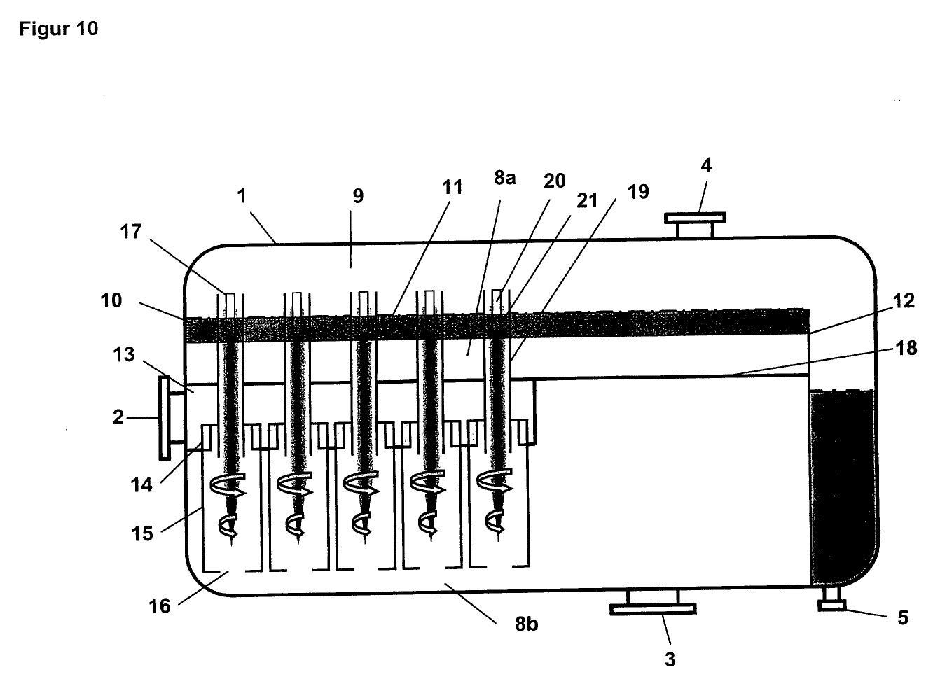

In a preferred embodiment of the current invention the oily layer (10) is removed continuously or periodically by letting the oily layer (10) in addition to parts of the continuous water phase flow over a weir plate (12) and out of the vessel (1) through a separate exit (5) such as shown in FIGS. 5 and 10. The weir plate (12) can be omitted such as shown in FIG. 8, but by using such a solution a larger part of the continuous water phase will be allowed to exit together with the dispersed oil phase.

The system as described can be controlled in many numbers of ways where in the subsequent sections a few examples, but not limiting the scope of the current invention, are given

A first example of a control method for such a system can be to apply a valve arranged on the pipe downstream the gas exit nozzle (4) for controlling the pressure in the separator, which is measured by a pressure sensor. Furthermore a valve arranged on the pipe downstream the water exit nozzle (3) is used for controlling the liquid level in the separator, which is measured by a level transmitter. The amount of dispersed oil and water flowing through the exit nozzle (5) is being measured by a flow meter and is controlled by a valve; both being installed on the pipe downstream the exit nozzle (5). If a weir plate (12) is applied the liquid level downstream the weir plate can be controlled instead of the level within the vessel. As previously mentioned the use of a weir plate (12) or similar flow arrangement can minimize the amount of water exiting together with the dispersed oil through the exit nozzle (5).

A second example of a control method for such a system can be to apply a valve arranged on the pipe downstream the gas outlet nozzle (4) for controlling the pressure in the separator, according to the first example. Similar to the first example it's convenient in addition to apply a valve installed on the pipe downstream the water outlet nozzle (3) in order to control the liquid level that is being measured by a level transmitter. A weir plate or similar flow arrangement is applied. The liquid level downstream the weir plate, measured by a designated level meter, is controlled using a valve arranged on the pipe downstream the exit nozzle (5). It's preferable, but not necessary, to also measure the volumetric flow rate of the liquid through the exit nozzle (5) with a designated flow meter installed on the pipe downstream the exit nozzle (5). The information gathered from the volumetric flow meter can be applied for set-point setting of optimal liquid levels within the vessel (1), which also are the levels the control system is working to achieve. The control method described will minimize the amount of water exiting together with the dispersed oil through the exit nozzle (5).

A third example of a control method for such a system can be to apply a valve arranged on the pipe downstream the gas outlet nozzle (4) for controlling the pressure in the separator, according to the first and second examples. Information from two pressure sensors, where one is measuring the pressure difference between the vessel's (1) inlet nozzle (2) and the pressure in the lower liquid section (8b) in the separator and the other pressure sensor is measuring the pressure difference between the vessel's (1) inlet nozzle (2) and the pressure in the upper liquid section (8a), are being used for controlling a valve installed on the pipe downstream the produced water outlet nozzle (3). Such a system requires at least one totally enclosing plate between the cyclone arrangement and the vessel's wall such that the lower liquid section (8b) and upper liquid section (8a) can communicate only through the cyclone pipes (15). The controlling parameter will be the ratio between the two pressure differences that should be maintained at a constant and pre-defined value. For a given cyclone geometry the laws of physics will provide that a pre-defined part of the total liquid flow will exit through the upper exit (17) of the cyclone pipe (15), independent of the total volumetric flow rate fed the cyclone pipe(s) (15). The liquid level within the vessel is controlled using a valve installed on the pipe downstream the exit nozzle (5).

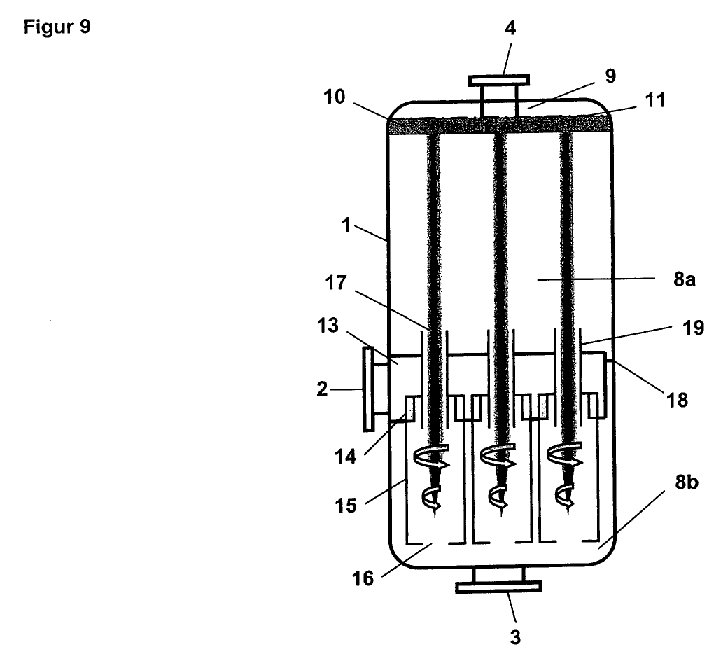

The dispersed oil phase can also be led together with the gas and parts of the continuous water flow through a common exit nozzle (4) as shown in FIG. 9. For such a solution the gas section (9) in the upper part of the vessel (1) need not exist since the existence will be dependent on the vertical extension of the exit pipe (4) into the vessel (1). This type of flotation separator configuration can be controlled in a number of ways of which three examples are described, not limiting the scope of the current invention, in the sub sequent sections.

A first example of a control method for such a system is to keep the pressure within the vessel at a constant value by measuring the pressure within the vessel and use this value to control the opening of a valve installed on the pipe downstream the water exit nozzle (3). Gas and liquid will flow out through the exit nozzle (4) toward a downstream vessel operating at a given pressure for further treatment. Additional control of the flotation separator is not required.

A second example of a control method for such a system consists of measuring the gas-liquid composition in the pipe downstream the exit nozzle (4) by using for example a radioactive source and receiver and using this parameter to control the opening of a valve arranged on the pipe downstream the water exit nozzle (3). Similar to the first example gas and liquids are flowing out of the exit nozzle (4) toward a downstream vessel operating at a given pressure for further treatment. The described control method will make a better control of the ratio of water exiting together with the gas and the dispersed phase compared to the first example.

A third example of a control method for such a system consists of using the information gathered from two pressure sensors, where one sensor is measuring the pressure difference between the vessel's (1) inlet nozzle (2) and the lower liquid section (8b) of the vessel (1), while the second sensor is measuring the pressure difference between the vessel's (1) inlet nozzle (2) and the pressure in the upper liquid section (8a) in the vessel (1), which information is used to control a valve installed on the pipe downstream the water outlet nozzle (3). Such a system requires at least one totally enclosing plate between the cyclone arrangement and the vessel's wall such that the lower liquid section (8b) and upper liquid section (8a) can communicate only through the cyclone pipes (15). The controlling parameter will be the ratio between the two pressure differences that should be maintained at a constant and pre-defined value. For a given cyclone geometry the laws of physics will provide that a pre-defined part of the of the total liquid flow will exit through the upper exit (17) of the cyclone pipe (15) and further through the vessel's (1) upper exit (4), independent of the total volumetric flow rate fed the cyclone pipe(s) (15). As in the other examples given, gas and liquids are flowing toward a downstream vessel operating at a given pressure for further treatment.

The examples given in the preceding sections are illustrated with a vertically arranged vessel, the current invention can however be applied for any arrangement of the vessel e.g. spherical, rectangular or horizontal vessels as shown in FIG. 10. If the components to be separated are n are given as none-hazardous to the environment the gas can be directly ventilated to the atmosphere, eventually after further treatment in a cleaning plant.

Comparison with Prior Art Technology

Since the centrifugal force achieved is inversely proportional to the diameter of the vessel, a much greater centrifugal force can be applied by using a cyclone arrangement according to the current invention compared to the other extreme where the total vessel volume is used as a cyclone, which is the case according to know technology.

Furthermore the radial distance the gas bubbles have to migrate is proportional with the diameter of the vessel, making the same number considerably smaller when using the cyclone arrangement according to the current invention than by using the whole vessel as a cyclone. Both effects contribute to a more effective flotation by using the cyclone arrangement according to the current invention.

Another significant benefit is that the cyclone arrangement according to the current invention can be installed in existing vessels.

Since the cyclone inlet according to prior art technology is using gas exits above the liquid surface it will be difficult to control conditions for the feeding liquids together with the concentrated dispersed phase out of the cyclone's upper exit, especially if the distance from the upper edge of the cyclone top exit and liquid surface increases as a consequence of level control within the vessel. For a cyclone arrangement according to the current invention where the cyclone's upper exit is submerged the performance will not be affected by level control since the pressure difference between the inlet and the outlet of the cyclone upper exit is not affected by the liquid level within the vessel.

1. Flotation separator for the separation of a dispersed liquid phase and/or solid materials from a continuous liquid phase containing free gas including; an open or a closed vessel (1) which is completely or partially filled with liquid, which vessel is equipped with at least one inlet nozzle (2) feeding the inflowing mixture fluid through at least one distribution chamber (13) toward at least one predominantly vertically arranged cyclone pipe (15) which is equipped with a swirl generating inlet device (14), a lower exit (16) which is leading the predominantly continuous liquid phase out of the cyclone pipe (15) and an upper exit (17) leading the gas, the dispersed liquid phase and/or solid materials out of the cyclone pipe(15), characterized in that the upper exit (17) is at a level that during operation the upper exit opening (17) is completely or partially submerged by the accumulated volume of liquid in the vessel.

2. Flotation separator according to claim 1, characterized in that the upper exit (17) is represented by an open end exit pipe (19) which is communicating with the interior volume of the cyclone pipe (15).

3. Flotation separator according to claims 1 and 2 claim 1, characterized in that the upper exit (17) is represented by slits or perforations (20) having a vertical extension near the upper end of the exit pipe (19) which is communicating with the interior volume of the cyclone pipe (15).

4. Flotation separator according to claim 1, characterized in that the upper exit (17) is represented by an open flow passage through an annulus formed by the cyclone pipe (15) and the concentric arranged exit pipe (19).

5. Flotation separator according to claim 1, characterized in that the upper exit (17) is represented both by an open passage through an annulus formed by the cyclone pipe (15) and the concentric exit pipe (19) and by an open ended exit pipe (19).

6. Flotation separator according to claim 1, characterized in that part of the gas is allowed to flow into the exit pipe (19) through slits or perforations in the sidewalls of the exit pipe (19).

7. Flotation separator according to claim 1, characterized in that the accumulated volume of continuous liquid phase is separated in an upper section (8a) in which the at least one cyclone pipe (15) upper exit is submerged, and a lower section (8b) in which the at least one cyclone pipe (15) lower exit is submerged, while the upper section (8a) is only communicating with lower section (8b) through the at least one cyclone pipe (15).

8. Flotation separator according to claim 1, characterized in that it further comprises completely or partially enclosing plates (18) between the cyclone pipes (15) and the vessel's (I) inner walls.

9. Flotation separator according to claim 1, characterized in that it further comprises completely or partially enclosing plates (18) between the at least one cyclone pipe (15) and the vessel's (1) inner walls.

10. Flotation separator according to claim 1, characterized in that it further comprises completely or partially enclosing plates (18) between the upper exit pipe (19) and the vessel's (1) inner walls.

11. Flotation separator according to claim 1, characterized in that it includes a number of substantially parallel cyclone pipes (15) that are fed through one common distribution chamber (13) or by any number of separate distribution chambers (13).

12. Flotation separator according to claim 11, characterized in that the number of cyclone pipes (15) in one separator is at least 3 and more preferred at least 6.

13. Flotation separator according to claim 1, characterized in that it comprises a designated exit (5) for the dispersed liquid phase or the solid, particulate material.

14. Flotation separator according to claim 13 characterized in that the designated exit (5) is arranged downstream of a weir plate (12).
